(19) United States
(12) Patent Application Publication
(10) Pub. No.: US 2026/0242003 A1
(43) Pub. Date: Aug. 20, 2026

(54) A UNITARY FIREWALL PANEL FOR A VEHICLE

(71) Applicant: AUTOTECH ENGINEERING SLL., Amorebieta-Etxano (Vizcaya) (ES)

(72) Inventors: Martín Antonio MECA MARTÍNEZ, Santpedor (Barcelona) (ES); Sergi MARQUEZ DURAN, Rajadell (Barcelona) (ES); Javier VALENCIA CARRIO, Manresa (Barcelona) (ES)

(21) Appl. No.: 19/472,082

(22) PCT Filed: Apr. 5, 2024
(86) PCT No.: PCT/EP2024/059306

§ 371 Date: Oct. 2, 2025

(30) Foreign Application Priority Data
Apr. 5, 2023 (EP) 23382332.7

(51) Int. Cl. B62D 25/08; B21D 22/02; B23K 26/244; B23K 101/00; B23K 101/18; B23K 103/04; B23K 103/10; B62D 27/02; B62D 29/00

(52) U.S. Cl. CPC B62D 25/085; B21D 22/022; B23K 26/244; B62D 27/023; B62D 29/007; B23K 2101/006; B23K 2101/185; B23K 2103/04; B23K 2103/10

(57) ABSTRACT

The present disclosure relates to methods for manufacturing a unitary firewall panel of a vehicle. The method comprises providing a plurality of blanks, joining the blanks to each other to form a combined blank, and hot stamping the combined blank to form the unitary firewall panel. The present disclosure further relates to unitary firewall panels obtainable by such methods.

The present application claims the benefit of European patent application no. 23 382 332.7 filed on April 5, 2023.

The present disclosure relates to firewall panels for vehicles, and more particularly relates to unitary firewall panels for vehicles and methods of manufacturing unitary firewall panels for vehicles.

### BACKGROUND

Vehicles such as cars incorporate a structural skeleton designed to withstand the loads that the vehicle may be subjected to during its lifetime. The structural skeleton is further designed to withstand and absorb impacts, in case of e.g. collisions with other cars or road structures.

The trend towards manufacturing low emission and more efficient vehicles has increased dramatically over last decades. The rapid development of hybrid and electric vehicles has forced the industry to design new car components, i.e. for weight reduction and therefore higher vehicle range, and for accommodating and protecting new car components among others. Thus, the demand for weight reduction in the automotive industry has led to the development and implementation of lightweight materials or components, and related manufacturing processes and tools. The demand for weight reduction is especially driven by the goal of a reduction of CO₂ emissions. The growing concern for occupant safety also leads to the adoption of materials which improve the integrity of the vehicle during a crash while also improving the energy absorption.

Press hardening, also known as Hot Forming Die Quenching (HFDQ) typically uses boron steel sheets to create stamped components with Ultra High Strength Steel (UHSS) properties, with tensile strengths of e.g. 1.500 MPa or 2.000 MPa or even more. The increase in strength allows for a thinner gauge material to be used, which results in weight savings over conventionally cold stamped mild steel components. Throughout the present disclosure UHSS may be regarded as a steel having an ultimate tensile strength of 1.000 MPa or more, particularly after a press hardening process.

In a HFDQ process, a blank to be hot formed may be heated to a predetermined temperature e.g. austenization temperature or higher (and particularly between Ac3 and an evaporation temperature of e.g. a coating of the blank). A furnace system may be used for this purpose. Depending on the specific needs, a furnace system may be complemented with additional heaters, e.g. induction or infrared heaters. By heating the blank, the strength of the blank is decreased and deformability increases i.e. to facilitate the hot stamping process.

There are several known Ultra High Strength steels (UHSS) for hot stamping and hardening. The blank to be hot formed may be made e.g. of a boron steel, coated or uncoated, such as Usibor® (22MnB5) commercially available from ArcelorMittal.

Typical vehicle components that may be manufactured using the HFDQ process include: door beams, bumper beams, cross/side members, A/B pillar reinforcements, front and rear rails, seat crossmembers and roof rails.

In order to improve the ductility and energy absorption in specific areas of a component, it is known to introduce softer regions within the same component. This improves ductility locally while maintaining the required high strength overall. By locally tailoring the microstructure and mechanical properties of certain structural components such that they comprise regions with very high strength (very hard regions), i.e. regions with high ultimate tensile strength and high yield strength and regions with increased ductility (softer regions), i.e. regions with lower ultimate tensile strength and lower yield strength and increased elongation before break, it may be possible to improve their overall energy absorption and maintain their structural integrity during a crash situation and also reduce their overall weight. Such soft zones may also advantageously change the kinematic behavior in case of a collapse of a component under an impact.

Known methods of creating regions with increased ductility (“softzones” or “soft zones”) in structural components of vehicles include the provision of tools comprising a pair of complementary upper and lower die units, each of the units having separate die elements (steel blocks). A blank to be hot formed is previously heated to a predetermined temperature e.g. austenization temperature or higher by, for example, a furnace system so as to decrease the strength i.e. to facilitate the hot stamping process.

The die elements may be designed to work at different temperatures, in order to have different cooling rates in different zones of the part being formed during the quenching process, and thereby resulting in different material properties in the final product e.g. soft areas which will generally have a lower ultimate tensile strength and a lower yield strength, but allow for more elongation before breaking. E.g. one die element may be cooled in order to quench the corresponding area of the component being manufactured at high cooling rates and to thereby reduce the temperature of the component rapidly and obtain a hard martensitic microstructure. Another neighboring die element may be heated in order to ensure that the corresponding portion of the component being manufactured cools down at a lower cooling rate, in order to obtain a softer microstructure, including e.g. bainite, ferrite and/or perlite. Such an area of the component may remain at higher temperatures than the rest of the component when it leaves the die.

Other methods for obtaining hot stamped components with areas of different mechanical properties include e.g. tailored or differentiated heating prior to stamping, and local heat treatments after a stamping process to change the local microstructure and obtain different mechanical properties. Yet further possibilities include the use of patchwork blanks, and Tailor Welded Blanks (TWB) combining different thicknesses and/or materials in blanks.

UHSS may exhibit tensile strengths as high as 1.500 MPa, or even 2.000 MPa or more, particularly after a press hardening operation. Once hardened, a UHSS may have a martensitic microstructure. This microstructure enables an increased maximum tensile strength and yield strength per weight unit.

In addition to the Ultra High Strength Steels mentioned before, more ductile steels may also be used in parts of the structural skeleton requiring energy absorption. These steels may be used in hot stamping processes but will not obtain a martensitic microstructure in the process. Ductibor® 1000 is an example of a suitable, more ductile steel.

Vehicles such as cars comprise a passenger compartment or cabin, which is the space adapted to receive the driver and the other travellers, and an engine compartment, which houses the motor among others and is arranged at the front of the passenger compartment.

The passenger compartment is separated from the engine compartment with a so-called “firewall”. Firewalls are generally made of lightweight materials and insulate the cabin from engine noises and heat.

Firewalls are commonly manufactured by welding together different workpieces which have been previously cold stamped or otherwise formed. These workpieces generally have different thicknesses and are made from different materials, particularly those suitable for cold stamping.

The firewall is generally not designed or configured to withstand and absorb impacts, in case of e.g. collisions with other cars, other vehicles or obstacles. Therefore, it is known to provide reinforcement members, which are commonly welded to the firewall such that, in case of a crash, the firewall is provided with elements which distribute impact forces to the structural skeleton of the vehicle e.g. rockers or hinge pillars.

Firewalls are manufactured separately from the reinforcements, which have different sizes and shapes depending on the specifications of firewall where they are being installed. These reinforcements comprise different thicknesses and different materials which enable the firewall to achieve required stiffness. For example, such reinforcements may be made from press hardened boron steel.

One problem that has been encountered is that manufacturing firewalls by welding stamped workpieces together is a slow process which produces some weak points in the structure. Another issue to be considered is that reinforcements welded to firewalls to make them more resistant to impact loads can increase the weight of the vehicle.

The present disclosure provides examples of systems and methods that provide improvements over prior art firewalls.

### SUMMARY

In a first aspect, a method for manufacturing a firewall panel is provided. The method comprises providing a plurality of blanks, joining the blanks to form a combined blank and hot stamping the combined blank to form the unitary firewall panel.

Joining the blanks to each other to form a combined blank and then hot stamping the combined blank, provides a light and resistant unitary firewall panel built in fewer steps, since welding operations after forming are reduced. Avoiding or reducing welding operations after forming also reduces the corresponding heat affected zones. The unitary firewall panel may have an enhanced crash performance while maintaining a reduced weight.

Hot stamping is a process which allows suitable deformation of e.g. ultra high strength steel to form the complicated resulting structure of the unitary firewall panel.

In some examples, blanks from different material thickness and/or grades may be used in order to satisfy specific strength and energy absorption and distribution requirements and optimizing weight.

In some examples, joining the blanks comprises forming one or more overlapping regions formed by partially overlapping the blanks with each other. In this disclosure, partially overlapping two blanks means that only a portion of the two blanks overlap.

The one or more overlapping regions may provide a firewall panel with regions with greater thickness, which may distribute crash energy to structural components of the vehicle skeleton. A firewall which is no longer a mere physical separation between the engine compartment and the passenger's cabin, but which also has a structural function may be provided. The unitary firewall panel may be stiffer and may be able to distribute crash energy, preferably, without the need of welding additional reinforcements. Improved crash performance of the vehicle may therefore be achieved with fewer components.

In some examples, an overlapping region may be formed along a longitudinal direction of the unitary firewall panel. A longitudinal direction may herein be regarded as a direction that is substantially transverse to the longitudinal direction of the vehicles. In a frontal crash, the overlapping regions may stiffen the firewall panel and may distribute impact energy to the sides of the firewall panel and to structural elements of the vehicle. A reinforcement in a region vulnerable to impact loads may be provided, and crash performance of the firewall panel may be improved.

In other examples, an overlapping region may be formed along a vertical direction of the unitary firewall panel. A stiffer firewall panel may be provided which may distribute impact load to structural elements of the vehicle e.g. the rockers, the tunnel or the hinge pillars. The overlapping region may be located at a first lateral side or at both lateral sides of the unitary firewall panel. An overlap along a vertical direction may also be located in a substantially central area, and in the lower half of the firewall panel. Such an overlap may locally strengthen the firewall panel and lead loads to e.g. the tunnel.

In some examples, deforming the combined blank may be done in a single operation. Deforming the combined blank in a single operation may result in the improvement of the efficiency of the manufacturing process of a firewall panel of a vehicle.

In examples, areas of increased thickness are provided in the combined blank (either by overlapping region or e.g. by providing a patch blank) such as to provide load paths to direct loads towards e.g. a hinge pillar, a floor or a tunnel. Such areas of increased thickness may be arranged such that the areas of the firewall panel that are joined to other parts of the vehicle framework are of increased strength and stiffness. Such areas of increased thickness may extend e.g. from a central area of the firewall panel (central in a horizontal direction and/or in a vertical direction) towards the areas where the firewall panel is joined to other components of a vehicle structural framework, particularly rockers, floor, tunnel, hinge-pillar or A-pillar.

In a further aspect, a unitary firewall panel as obtained by a method according to any of the examples herein described is provided.

### BRIEF DESCRIPTION OF THE DRAWINGS

Non-limiting examples of the present disclosure will be described in the following, with reference to the appended figures, in which:

FIG. 1 shows an example of a firewall of a vehicle according to the state of the art;

FIG. 2a shows an example of a plurality of blanks prior to being joined to form a combined blank;

FIG. 2b shows an example of a combined blank formed by two joined blanks;

FIG. 3a shows a further example of a plurality of blanks prior to being joined to form a combined blank;

FIG. 3b shows an example of a combined blank formed by joining the blanks of FIG. 3a;

FIG. 4 shows an example of a combined blank comprising a patch blank;

FIG. 5 shows a further example of a combined blank comprising patch blanks;

FIG. 6 shows an example of a unitary firewall panel of a vehicle according to the present disclosure; and

FIG. 7 is a flow chart of a method for manufacturing a unitary firewall panel of a vehicle.

The figures refer to example implementations and may only be used as an aid for understanding the claimed subject matter, not for limiting it in any sense.

### DETAILED DESCRIPTION OF EXAMPLES

In these figures, the same reference signs have been used to designate matching elements.

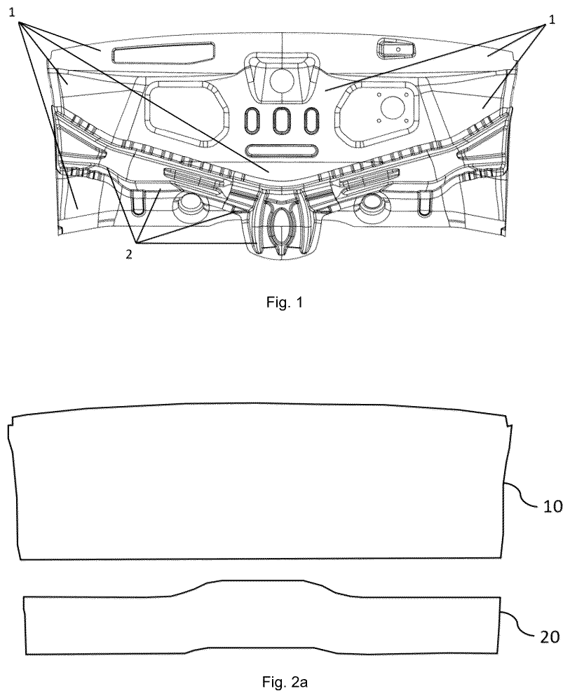

FIG. 1 schematically represents a firewall panel of the state of the art. The firewall panel is made from a plurality of independent cold formed components 1 which are subsequently welded together. The plurality of cold formed components may comprise different shapes and different thicknesses. The firewall panel is a mere physical separation between the engine compartment and the passenger's cabin of a vehicle and is not configured to withstand and absorb impacts, in case of e.g. collisions with other cars.

In addition, the firewall panel comprises a plurality of cross-members 2 or reinforcement members extending along a longitudinal direction of the firewall panel. These cross-members 2 are welded to the firewall panel and act as reinforcements in crash events.

In one aspect of the disclosure, a unitary firewall panel 100 is provided. The unitary firewall panel 100 is made from a plurality of blanks joined together to form a combined blank. The unitary firewall panel is obtained after hot stamping the combined blank. A unitary firewall panel with enhanced crash performance may therefore be obtained.

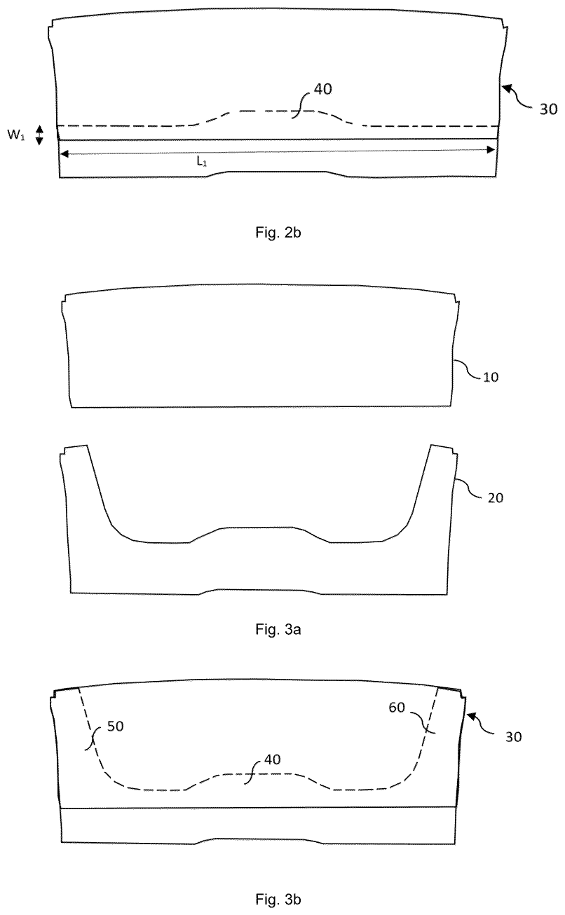

As schematically illustrated in FIG. 2a, a unitary firewall panel 100 may be manufactured by joining a first blank 10 and a second blank 20 to form a combined blank 30. In the example of FIG. 2a, the first blank 10 may define the upper part of the firewall panel whereas the second blank 20 may define the lower part of the firewall panel. In other examples, the unitary firewall panel 100 may be manufactured by joining blanks defining other parts of the firewall panel or by joining more than two blanks.

The blanks may have a thickness of between 0.5-5 mm, preferably, 0.8-3 mm. In some examples, the thickness of the various blanks may be substantially the same. In other examples, depending on the position of the blank in the firewall panel, different thicknesses of the blanks may be desired and blanks with different thicknesses may be joined to form the combined blank. Further, the plurality of blanks 10, 20 that form the combined blank 30 may be made from different materials. In some examples, the blanks 10, 20 may be made from ultra high strength steels (UHSS) e.g. Usibor® or Ductibor®. In other examples, aluminium blanks, e.g. aluminium from 6000 or 7000 series may be used.

A combined blank 30 including the two blanks 10, 20 may thus be formed as shown in FIG. 2b by joining a first blank 10 and a second blank 20. Joining the blanks may comprise forming one or more overlapping regions formed by partially overlapping the blanks with each other i.e. one blank may only be partially positioned over another blank and the blanks are then joined to each other. The overlapping region may have a width of at least 5 cm in some examples. An overlapping region thus acquires an increased thickness as compared to the remainder of the blanks. Such an increase in thickness can be used to tailor mechanical properties as needed and provide local strength and/or stiffness in the unitary firewall panel in areas where in the prior art, a reinforcement is required.

In addition, overlapping regions may be used to disperse impact energy to other parts of the vehicle. Overlapping regions may comprise load paths which may transfer impact energy to other elements of the vehicle configured to absorb such energy. In case of e.g. a frontal impact, impact load may be transmitted throughout the firewall to structural elements of the vehicle which are designed to absorb the energy produced in the crash. Additional structural reinforcements in the firewall panel may thus be avoided and crash performance of the firewall may be improved while reducing components.

Joining of the blanks may be done by any of laser welding, spot welding or arc welding.

Referring back to FIG. 2b, an overlapping region 40 may be formed along a longitudinal direction of the unitary firewall panel when joining the first and second blanks 10, 20 from FIG. 2a. The overlapping region 40 may form a horizontal strip in the lower half of the firewall panel, i.e. the overlapping region 40 may be a substantially straight region that is vertically displaced from the centre towards a bottom of the combined blank 30. The overlapping region 40 may extend from a first end to a second end of the combined blank 30, i.e. over the entire length of the firewall panel (or over substantially the entire width of the vehicle). In addition, both ends of the overlapping region may be vertically aligned.

In a frontal crash, the overlapping regions along a longitudinal direction may stiffen the firewall panel and may distribute impact energy to structural elements of the vehicle. Additional structural reinforcements in the firewall panel may thus be unnecessary. A unitary firewall panel may thus be obtained comprising a reinforcement along a longitudinal direction which in case of frontal impact e.g. with another car, may disperse crash loads. Therefore, a unitary firewall manufactured with few workpieces and capable of distributing crash energy may be provided.

In some examples, the overlapping region may have a length Li corresponding to a length of the unitary firewall panel 100. In the example of FIG. 2b, the overlapping region may have a length L1 corresponding to a length of the unitary firewall panel and may have a width W1 of at least 1 cm, for example, between 1-5 cm. In some examples, the width of the overlapping region may be of at least 5 cm. In some examples, the width of the overlapping region may not be constant e.g. the overlapping region may be wider towards a central portion of the combined blank 30. Suitable dimensions for the overlapping region 40 may be chosen taking into account weldability, strength, stiffness and energy distribution requirements. A larger overlapping region 40 means an increase in thickness over a larger area, and thus an increase in strength and stiffness locally in the unitary firewall panel 100 as well as enhanced energy distribution.

In a subsequent step, the combined blank 30 is hot stamped and the unitary firewall panel is formed. Particularly, the combined blank may be heated to above an austenization temperature, e.g. around 900-920° C. in a furnace. And subsequently, the combined blank may be deformed and hardened in a press apparatus. Particularly, rapid cooling above a critical cooling rate of the combined blank may achieve a martensitic microstructure and high ultimate tensile strength and high yield strength.

In some examples, partially overlapping the blanks with each other may comprise forming an overlapping region in a substantially vertical direction of the unitary firewall panel 100.

FIG. 3a shows another example of joining a first blank 10 and a second blank 20 to form a combined blank 30. As shown, the blanks in FIG. 3a have different shapes from the shapes of the blanks in the example of FIG. 2a, and therefore, a different overlapping region 40 from the one in FIG. 2b will be obtained by partially overlapping the blanks 10, 20 with each other.

In the example of FIG. 3b, a substantially U-shaped overlapping region may be formed by partially overlapping the blanks 10, 20 with each other. In addition to the overlapping region 40 also formed in FIG. 2b, one or more overlapping regions 50, 60 may be formed along a vertical direction of the unitary firewall panel such that an overlapping region may be located at a first lateral side of the unitary firewall panel 100. FIG. 3b shows a first lateral side of the combined blank 30 comprising a first vertical overlapping region 50 and a second lateral side of the combined blank 30 comprising a second vertical overlapping region 60. In some examples, the vertical overlapping regions may comprise a width of at least 1 cm, preferably of at least 5 cm. Overlapping regions located at a lateral side of the unitary firewall panel may provide additional thickness in said region and may provide a unitary firewall panel which may disperse load coming from a frontal impact to e.g. the rockers and/or hinge pillars of the vehicle.

Further, the size and shape of the blanks may depend on where an overlapping region 40, 50, 60 may be desired in the blank. In other examples, a first blank which may define the left side of the firewall panel may be joined to a second blank which may define the right side of the panel forming a vertical overlapping region substantially in the centre of the firewall panel. This may lead to a unitary firewall panel which may have increased stiffness in a central part and along a substantially vertical direction and which may be able to distribute impact loads to structural elements of the vehicle body e.g. the tunnel.

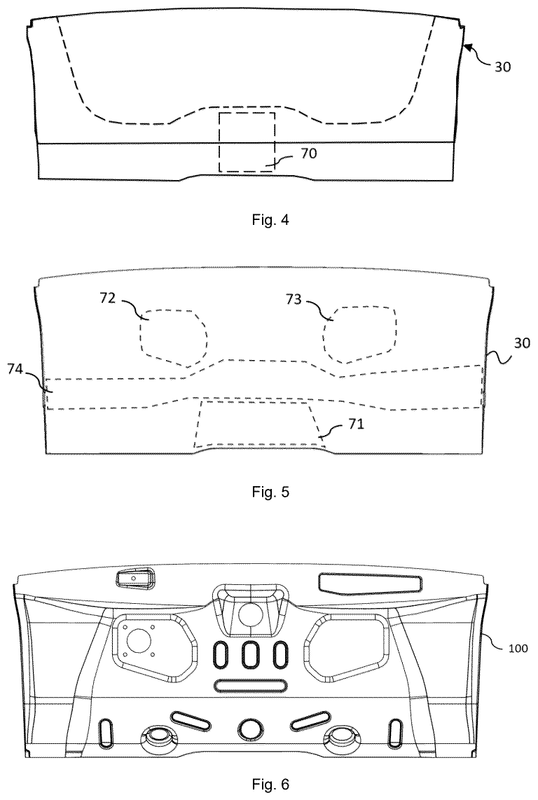

As schematically illustrated in FIG. 4, in some examples a patch blank 70 may be joined to at least one of the plurality of the blanks that form the combined blank 30. The patch blank 70 may be added substantially in a central portion of one of the blanks. A patch blank 70 may be added as a reinforcement in order to increase strength and distribute impact load of a specific area of the combined blank 30 to structural parts of the vehicle configured to absorb impact energy such as the tunnel of the floor and the rockers.

In this particular example, a patch blank 70 has been added to the central portion of blank 20, in a substantially central lower part of the combined blank 30 such that load energy can be transmitted to the tunnel of the vehicle. In other examples, a patch blank 70 may be arranged along a vertical direction of the combined blank 30, optionally on a first lateral side of the combined blank. Impact load may therefore be distributed to the hinge pillars of the vehicle and/or to the rockers.

The patch blanks 70 may be joined to the blanks by overlapping one of the blanks with the other blank and using spot welding. In other examples, alternative welding techniques may be used e.g. laser welding or arc welding.

FIG. 5 schematically represents a further example of a combined blank 30 comprising four patch blanks. As shown in FIG. 6, a first patch blank 71 may be joined to a lower central portion of a blank, which in case of an impact, may direct impact load to the tunnel of the floor of the vehicle. A second and a third patch blank 72, 73 may be joined to an upper portion of the combined blank, i.e. in an upper half of the panel. The second and third patch blanks are shown positioned offset from a vertical central line of the panel.

In addition, the blank 10 from FIG. 6 may also comprise a fourth patch blank 74 which may extend longitudinally from side to side of the combined blank and which may be located in between the first 71 and the second and third patch blanks 72, 73. In other examples, the combined blank may comprise additional patch blanks or less patch blanks, depending on where increased strength and/or impact load distribution may be desired in the unitary firewall panel.

In other examples, the blanks 10, 20 joined to form the combined blank 30 may be formed by a plurality of blanks or sub-blanks, e.g. of different thicknesses and/or different materials. In these examples, the plurality of blanks may be Tailor Welded Blanks (TWB). The TWB may be formed by joining the sub-blanks by edge-to-edge welding, wherein welding may comprise laser welding. In other examples, the plurality of blanks joined to form the combined blank may be joined by forming one or more overlapping regions formed by partially overlapping the blanks with each other. In these cases, any of laser welding, arc welding or spot welding may be used.

In some examples, the plurality of blanks 10, 20 that form the combined blank 30 may be made from different materials. In some examples, the blanks 10, 20 may be made from ultra high strength steels (UHSS). Boron steel, e.g. 22MnB5, or other steel compositions mentioned or referred to before may be suitable UHSS. These blanks, e.g. boron steel blanks, may comprise an aluminium silicon coating or zinc coating.

Usibor® 1500P is an example of a 22MnB5 steel. The composition of Usibor® is summarized below in weight percentages (rest is iron (Fe) and impurities):
Maximum carbon (C) (%): 0.25
Maximum silicon (Si) (%): 0.4
Maximum manganese (Mn) (%): 1.4
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.01
Maximum copper (Cu) (%): 0.20
Maximum boron (B) (%): 0.005
Maximum chromium (Cr) (%): 0.35

Usibor® 1500P may have a yield strength of e.g. 1.100 MPa, and an ultimate tensile strength of 1.500 MPa.

Usibor® 2000 is another boron steel with even higher strength. The yield strength of Usibor® 2000 may be 1.400 MPa or more, and the ultimate tensile strength may be above 1.800 MPa. The composition of Usibor® 2000 is summarized below in weight percentages (rest is iron (Fe) and impurities):
Maximum carbon (C) (%): 0.36
Maximum silicon (Si) (%): 0.8
Maximum manganese (Mn) (%): 0.8
Maximum phosphorus (P) (%): 0.03
Maximum sulphur(S) (%): 0.01
Aluminium (Al) (%): 0.01-0.06
Maximum titanium (Ti) (%): 0.07
Maximum niobium (Nb) (%): 0.07
Maximum copper (Cu) (%): 0.20
Maximum boron (B) (%): 0.005
Maximum chromium (Cr) (%): 0.50
Maximum molybdenum (Mb) (%): 0.50

The plurality of blanks that form the combined blank 30 may comprise different material and/or thicknesses. For example, blanks of Usibor® (e.g. Usibor® 1500 and/or Usibor® 2000) may be used in the blanks forming the combined blank 30. Using these types of materials in hot forming and subsequent quenching processes leads to a predominantly martensitic structure due to the Usibor®. One or more of the blanks may be made from a different and particularly a more ductile material, e.g. Ductibor® 1000.

Ductibor® 1000 is another material used in hot stamping for increasing the elongation when compared to Usibor® 1500 and Usibor® 2000. The yield strength of Ductibor® 1000 may be 800 MPa or more, and the ultimate tensile strength of 1000 MPa or more. The composition of Ductibor® 1000 is summarized below in weight percentages (rest is iron (Fe) and impurities):
Maximum carbon (C) (%): 0.10
Maximum silicon (Si) (%): 0.6
Maximum manganese (Mn) (%): 1.8
Maximum phosphorus (P) (%): 0.03
Maximum sulphur(S) (%): 0.01
Aluminium (Al) (%): 0.01-0.1
Maximum titanium (Ti) (%): 0.05
Maximum niobium (Nb) (%): 0.10
Maximum copper (Cu) (%): 0.20
Maximum boron (B) (%): 0.005
Maximum chromium (Cr) (%): 0.20

In other examples, the plurality of blanks 10, 20 that form the combined blank 30 may be made from aluminium. The aluminium of the plurality of blanks may be an aluminium alloy selected from the groups 6000 and 7000 series aluminium alloys. These series are characterized by their strength, corrosion resistance and weldability.

In some examples, the unitary firewall panel 100 may comprise areas with different ultimate tensile strength according to any of the examples herein described. In some of these examples, different materials may be used in the combined blank 30.

In some of these examples, the areas with different ultimate tensile strength may have a different microstructure.

Different microstructures may be created in a hot formed firewall panel 100. These different microstructures may be created by heating a combined blank 30 above the austenitization temperature and then controlling the cooling of the combined blank 30 during shaping the combined blank 30 to form a unitary firewall panel 100 of a vehicle. The cooling of different areas of the combined blank 30 may be controlled by providing zones of the forming tool with heaters. Accordingly, the unitary firewall panel 100 comprises zones with a predominantly martensitic structure and zones comprising ferrite, perlite or bainite or a mixed of thereof. Alternatively, a different microstructure, may be created by partially heating, e.g. using a laser beam, a portion of the unitary firewall panel which has been press-hardened to change the predominantly martensitic structure to a structure containing ferrite and/or perlite and/or bainite and/or tempered martensite and a mixed of thereof. The tensile strength of the predominantly martensitic structure may be above 1400 MPa, and specifically above 1500 MPa.

The unitary firewall panel 100 may thus be made from a material which may be effective for absorbing energy during an impact. In some examples, the plurality of blanks 10, 20 may be made at least from an ultra high strength steel.

The plurality of blanks may have an ultimate tensile strength of 1.000-2.000 MPa, specifically of 1.500-2.000 MPa.

In some examples, the thickness of the plurality of blanks may be different e.g. the thickness of a first blank 10 may be different than a thickness of a second blank 20.

In some examples, joining the blanks to each other comprises welding the blanks to each other. In some examples, the blanks may be welded by spot welding and/or laser welding. Joining the blanks before the deformation may make the joining easier due to the blanks being substantially flat at the moment of joining. Welding blanks prior to the deformation process by laser and/or spot welding may be efficient and precise.

In some examples, hot stamping or hot forming the combined blank may comprise heating the combined blank 30 above the austenitization temperature, and then forming the combined blank 30 to create the unitary firewall panel 100. In some examples, forming may comprise two or more forming steps. These forming steps may comprise for example shaping, trimming or cutting and may be made in a single multi-stage press. Examples of multi-stage presses are known from e.g. U.S. Pat. No. 9,492,859 B2 and WO 2016142367 A1.

Deforming may include hot forming, i.e. heating the combined blank 30 in an oven, possibly above an austenization temperature, specifically above Ac3. After heating in the oven, the combined blank 30 may be transferred to a press in which the combined blank 30 is deformed to obtain the final shape of the unitary firewall panel 100. During and immediately after forming, quenching may be carried out. In particular, the quenching may include cooling above a critical cooling rate so that a martensitic microstructure is obtained. In some examples, quenching may be avoided in selected portions of the firewall panel.

In some examples, deforming may be done in one single operation.

FIG. 6 schematically represents a unitary firewall panel 100 according to an example of the present disclosure. The unitary firewall panel 100 is made from a plurality of blanks joined together to form a combined blank. The unitary firewall panel is obtained after hot stamping the combined blank.

In some examples, the unitary firewall panel 100 may be arranged between the passenger's compartment and the engine compartment of a vehicle and may be joined to other parts of the vehicle framework, like the hinge pillars and the floor e.g. by welding.

A firewall which is no longer a mere physical separation between the engine compartment and the passenger's cabin may be provided. The unitary firewall panel 100 of the present disclosure may have increased stiffness and may have load paths which may transmit impact loads produced in a crash event to other parts of the vehicle designed to absorb such impact loads e.g. hinge-pillars, A-pillars, the rockers or the floor tunnel. In addition, the unitary firewall panel may be produced with few processes. Therefore, the crash performance may be improved while avoiding the need of welding additional structural reinforcements to the firewall panel.

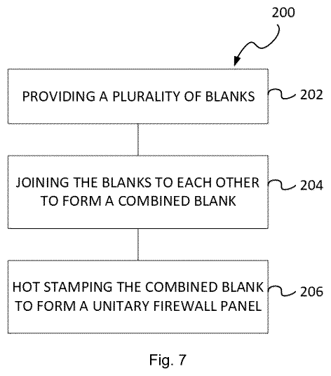

FIG. 7 represents a flow chart of a method 200 for manufacturing a unitary firewall panel of a vehicle. The method comprises providing a plurality of blanks 202; joining the blanks to each other to form a combined blank 204; hot stamping the combined blank to form a unitary firewall panel 206.

In some examples, the plurality of blanks 10, 20 that form the combined blank 30 may be made from different materials. In some examples, the plurality of blanks 10, 20 may be made from an ultra high strength steel or from aluminium.

In some examples, joining the blanks to each other to form a combined blank 202 may comprise forming one or more overlapping regions 40, 50, 60 formed by partially overlapping the blanks to each other. Overlapping regions provide an increased thickness and may provide stiffness to the unitary firewall panel and be used to disperse impact energy to other parts of the vehicle.

Overlapping regions may be arranged such as to provide load paths to direct loads towards e.g. a hinge pillar, a floor or a tunnel. Overlapping regions may be arranged such that the areas of the firewall panel that are joined to other parts of the vehicle framework are of increased strength and stiffness.

In some examples, an overlapping region may be formed along a longitudinal direction of the unitary firewall panel. A unitary firewall panel which may be stiffer in a longitudinal direction and which may be able to distribute impact loads to structural parts of the vehicle may be provided.

Hot stamping or hot forming the combined blank to form a unitary firewall panel 206 may comprise the creation of different microstructures in the hot formed firewall panel. These different microstructures may be created by heating a combined blank 30 above the austenization temperature. In some examples, during and after forming, quenching may be carried out. Quenching may include cooling above a critical cooling rate so that a martensitic microstructure is obtained.

In some examples, different microstructures may be obtained by heating a combined blank 30 above the austenization temperature and then controlling the cooling of the combined blank 30 during shaping the combined blank 30 to form a unitary firewall panel 100. In some examples, quenching may be avoided in selected portions of the unitary firewall panel 100.

In some examples, hot stamping the combined blank to form a unitary firewall panel 206 may be done in a single operation.

Although only a number of examples have been disclosed herein, other alternatives, modifications, uses and/or equivalents thereof are possible. Furthermore, all possible combinations of the described examples are also covered. Thus, the scope of the present disclosure should not be limited by particular examples, but should be determined only by a fair reading of the claims that follow.

1. A method for manufacturing a unitary firewall panel of a vehicle comprising:
providing a plurality of blanks;
joining the blanks to form a combined blank;
hot stamping the combined blank to form the unitary firewall panel, wherein joining the blanks comprises forming an overlapping region by partially overlapping the blanks with each other, and
wherein the overlapping region is formed along a longitudinal direction of the unitary firewall panel and extends along an entire length of the unitary firewall, the longitudinal direction being transverse to a longitudinal direction of the vehicle.

2. (canceled)

3. The method according to claim 1, wherein the overlapping region is substantially U-shaped.

4. The method according to claim 1, wherein the overlapping region has a width of at least 5 cm.

5. The method according to claim 1, wherein deforming is done in one single operation.

6. The method according to claim 1, wherein the combined blank comprises at least a patch blank.

7. The method according to claim 6, wherein the patch blank is arranged along a vertical direction of the combined blank.

8. The method of claim 7, wherein the patch blank is arranged on a first lateral side of the combined blank.

9. The method according to claim 6, wherein the patch blank is arranged in a substantially central lower part of the combined blank.

10. The method according to claim 1, wherein joining the blanks comprises welding the blanks to each other.

11. The method of claim 10, wherein welding comprises laser welding.

12. The method according to claim 1, wherein the plurality of blanks is made of an ultra high strength steel.

13. The method according to claim 1, wherein the plurality of blanks is made of aluminium.

14. A unitary firewall panel obtainable by a method according to claim 1.

15. (canceled)

16. A method for manufacturing a unitary firewall panel of a vehicle comprising:
providing a plurality of blanks;
joining the blanks to form a combined blank;
hot stamping the combined blank to form the unitary firewall panel, wherein joining the blanks comprises forming an overlapping region by partially overlapping the blanks with each other, and
wherein the overlapping region includes a first portion formed along a vertical direction of the unitary firewall panel at a first lateral side of the unitary firewall panel and a second portion formed along the vertical direction of the unitary firewall panel at a second lateral side of the unitary firewall panel.

17. The method of claim 16, wherein the overlapping region is substantially U-shaped and extends from the first lateral side to the second lateral side.

18. The method according to claim 1, wherein the combined blank comprises at least a patch blank.

19. The method according to claim 18, wherein the patch blank is arranged in a substantially central lower part of the combined blank.

20. The method according to claim 19, the plurality of blanks is made of an ultra high strength steel.
